(19) United States
(12) Patent Application Publication
(10) Pub. No.: US 2018/0350004 A1
(43) Pub. Date: Dec. 6, 2018

(54) SYSTEMS AND METHODS FOR GENERATING AN ENHANCED INDEX PORTFOLIO BY DISAGGREGATING A TOTAL RETURN OF AN INVESTMENT INSTRUMENT

(71) Applicant: Efficient Alpha Capital LLC, Venice, CA (US)

(72) Inventor: Doug Scherrer, Venice, CA (US)

(21) Appl. No.: 15/988,813

(22) Filed: May 24, 2018

Related U.S. Application Data
(60) Provisional application No. 62/515,917, filed on Jun. 6, 2017.

(51) Int. Cl. G06Q 40/06

(52) U.S. Cl. CPC G06Q 40/06

(57) ABSTRACT

A system for generating an index portfolio by disaggregating a total return of an investment instrument is provided. The system is programmed to perform the steps of defining an analysis period, accessing financial data for a plurality of investment instruments over the analysis period, and evaluating a total return for each investment instrument based on the financial data. The evaluation includes determining a change in valuation multiple for each investment instrument over the analysis period and determining a fundamental performance of each investment instrument over the analysis period. The system is also programmed to perform selecting investment instruments from the plurality of investment instruments to include in a fund index based on primary selection criteria.

### CROSS REFERENCE TO RELATED APPLICATIONS

This application claims the benefit of U.S. Patent Application No. 62/515,917, entitled “SYSTEMS AND METHODS FOR GENERATING AN ENHANCED INDEX PORTFOLIO BY DISAGGREGATING A TOTAL RETURN OF AN INVESTMENT INSTRUMENT,” which was filed Jun. 6, 2017, which is hereby incorporated by reference in its entirety.

### BACKGROUND

The field of the present disclosure relates generally to data analytics and, more specifically, to systems and methods of analyzing and creating an enhanced index portfolio based on a disaggregation of an investment instrument's total return.

Portfolio management of securities is generally classified in two basic forms; active management and passive management. Active management includes evaluating potential investment securities for inclusion in a portfolio based on one or more portfolio managers' judgment and experience, and also based on a detailed analysis of the financial health of the company. However, active management of an equity portfolio is an inherently subjective exercise, and actively managed portfolios have historically underperformed relative to traditional market indices, such as the Dow Jones Industrial Average, the Nasdaq Composite Index, and the S&P 500. Moreover, actively managed equity portfolios are generally associated with high fees, which further decreases the likelihood that the portfolios will outperform traditional market indices.

In contrast, passive management includes forming an equity portfolio that matches a traditional market index. Passive management is defined by adherence to the efficient market hypothesis, which theorizes that it is impossible to outperform the market on a long term basis. Passive management is also typically associated with lower fees than actively managed portfolios. However, the efficient market hypothesis is not a universally accepted theory, and many well-known fund managers have regularly outperformed traditional market indices. As such, there is a need for a portfolio management strategy that is sensitive to management fees and commissions, that is objective, and that is capable of outperforming traditional market indices.

### BRIEF DESCRIPTION

In one aspect, a system for generating an index portfolio by disaggregating a total return of an investment instrument is provided. The system includes at least one processor in communication with at least one memory device. The at least one processor is in communication with at least one database. The at least one processor is programmed to perform the steps of defining an analysis period, accessing, via the at least one database, financial data for a plurality of investment instruments over the analysis period, and evaluating a total return for each investment instrument based on the financial data. The evaluation includes determining a change in valuation multiple for each investment instrument over the analysis period and determining a fundamental performance of each investment instrument over the analysis period. The at least one processor is also programmed to perform selecting investment instruments from the plurality of investment instruments to include in a fund index based on primary selection criteria. The primary selection criteria is satisfied when the change in valuation multiple for an investment instrument over the analysis period is less than a first predetermined threshold, and when the fundamental performance of an investment instrument over the analysis period is greater than a second predetermined threshold.

In another embodiment, a system for analyzing a plurality of investment instruments in a portfolio using a disaggregation calculation is provided. The system including at least one processor in communication with at least one memory device. The at least one processor in communication with at least one database. The at least one processor programmed to perform the steps of: defining an analysis period, accessing, via the database, financial data for the plurality of investment instruments over the analysis period, and evaluating a total return for each investment instrument based on the financial data. The evaluation includes determining a change in valuation multiple for each investment instrument over the analysis period and determining a fundamental performance of each investment instrument over the analysis period.

### BRIEF DESCRIPTION OF THE DRAWINGS

FIG. 1 is a block diagram illustrating an example computing system configured to analyze and create an index portfolio;

FIG. 2 is a block diagram illustrating an example client device that may be used in the computing system shown in FIG. 1;

FIG. 3 is a block diagram illustrating an example server system that may be used in the computing system shown in FIG. 1;

FIG. 4 is a flow diagram illustrating example instructions that may be executed by a processor when analyzing and creating an enhanced index portfolio; and

FIG. 5 is an illustration of an example spreadsheet that may be generated to analyze the results of a disaggregation calculation and creation of the enhanced index portfolio.

### DETAILED DESCRIPTION

The embodiments described herein relate generally to systems and methods of analyzing and creating an enhanced index portfolio based on a disaggregation of an investment instrument's total return. More specifically, the method includes extracting historic and current financial data for each investment instrument to be analyzed, and performing a disaggregation calculation of the total return using the financial data to determine the sources of a return of an investment instrument's total return, such as a change in valuation multiple and a fundamental financial performance of the investment instrument over a given period. It has been determined that the change in valuation multiple and fundamental financial performance of an investment instrument are primary drivers in determining the financial health, viability, and investment potential of an investment instrument. The change in valuation multiple is determined as a function of an investment instrument's enterprise value and earnings before interest, tax, depreciation, and amortization (EBITDA). The fundamental financial performance is determined as a function of an investment instrument's revenue growth, margin change, dividend yield, change in net cash, and change in fully-diluted shares outstanding over a given period. By definition, the fundamental financial performance should equal the difference between the total return and the change in valuation multiple. The results of the disaggregation calculation can then be displayed to analyze the sources of return on a given portfolio of equities.

In one embodiment, the method also includes applying predetermined thresholds to each result (i.e., the sources of return) of the disaggregation calculation for investment instruments in a universe, and selecting investment instruments from the universe to include in a fund index or basket based on the performance of the investment instruments relative to the predetermined thresholds. A fund index or basket is a set of investment instruments that meet the desired criteria. For example, in one embodiment, a total percentage change in total return for an investment instrument is disaggregated to determine how much of the total percentage change is attributable to each source of return. For example, if a total return of an investment instrument increases by 20 percent, the disaggregation calculation facilitates determining how much of the percentage change is attributable to the change in valuation multiple (e.g., 5 percent), and how much of the percentage change is attributable to the fundamental performance (e.g., 15 percent). A threshold is then applied to each disaggregated source of return, and the investment instrument is selected for inclusion in the fund index or basket when the percentage change attributable to the change in valuation multiple is less than a first threshold, and when the percentage change attributable to the fundamental performance is greater than a second threshold, for example. The sum of each result equals the total return of a given investment instrument. As such, a more accurate and comprehensive analysis of the investment instrument is performed.

The fund index or basket may further be refined based on supplemental criteria, such as revenue growth over the given period and an absolute level of an investment instrument's valuation multiple. The final fund index or basket of investment instruments is then used to create an enhanced index portfolio. In addition, the disaggregation calculation may be applied to data available at dates in the past, such that a historical portfolio and a back-tested performance of the investment instrument selection methodology is determinable. As such, the systems and methods described herein facilitate identifying investment instruments characterized by superior fundamental financial performance, and determining the financial health and viability of an underlying company associated with an investment instrument in an objective and mathematical manner. Accordingly, the fund index or basket of investment instruments is theoretically capable of outperforming traditional market indices on a long term basis. In addition, an equity portfolio or enhanced index portfolio created using this methodology is maintainable in an efficient manner and with minimal or no active management to facilitate keeping fees low.

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured collection of records or data that is stored in a computer system. The above examples are example only and thus are not intended to limit in any way the definition and/or meaning of the term database. Examples of RDBMS's include, but are not limited to including, NoSQL, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

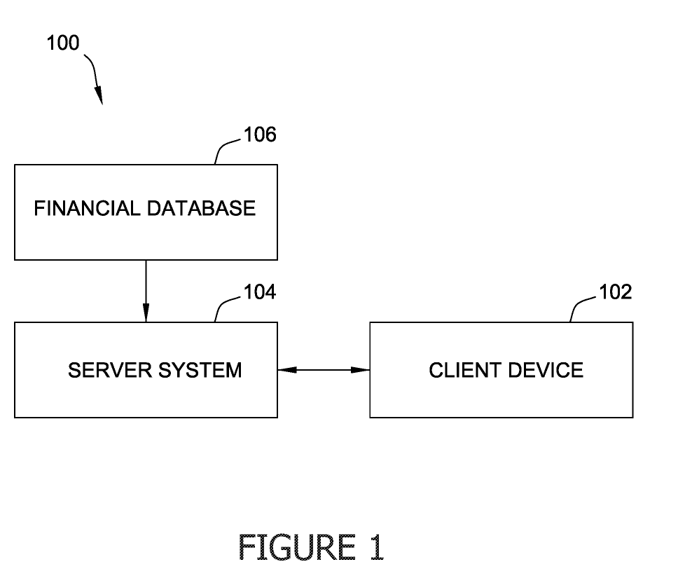

FIG. 1 is a block diagram illustrating an example computing system 100 configured to analyze and create an index portfolio, to overcome the technical problems described above, and to confer the substantial technical effects and technical benefits disclosed herein. Computing system 100 includes a client device 102 and a server system 104 in communication with each other, and a financial database 106 in communication with server system 104. Client device 102 and server system 104 will be described in greater detail below.

In the exemplary embodiment, client devices 102 are computers that include a web browser or a software application, which enables client devices 102 to access remote computer devices, such as server system 104, using the Internet or other network. More specifically, client devices 102 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client devices 102 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

In the exemplary embodiment, server system 104 is a remote server accessed in the execution of analyzing a plurality of investment instruments in a portfolio using a disaggregation calculation. In the exemplary embodiment, server system 104 is a computer that allows remote computers that include a web browser or a software application, such as client devices 102, to access for communication, using the Internet or other network. More specifically, server system 104 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Server system 104 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

In the example embodiment, financial database 106 is a subscription-based financial data service that stores historic and current financial data for a plurality of investment instruments therein. Example investment instruments include, but are not limited to, stocks and bonds. As will be explained in more detail below, financial database 106 transmits the financial data to server system 104, and server system 104 uses the financial data to analyze and create an index portfolio, for example. Example financial data includes, but is not limited to, security pricing data (including daily updated pricing data) and data included in the financial statements disclosed in a quarterly earnings report. In the exemplary embodiment, a user, may access database 106 via client device 102 by logging onto server system 104, as described herein. In some embodiments, database 106 includes any computer server, cloud or other digital data storage device.

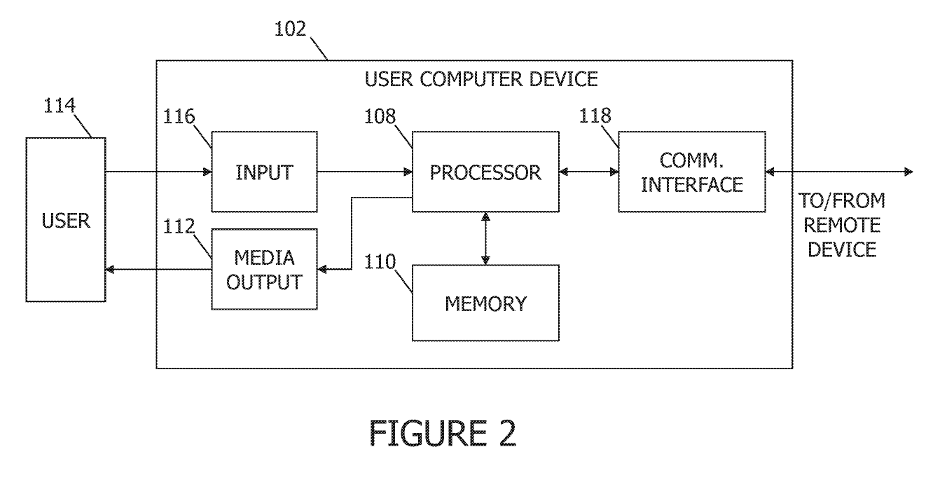

FIG. 2 is a block diagram illustrating an example client device 102 that may be used in computing system 100 (shown in FIG. 1). In some embodiments, client device 102 may be used to access the results of a disaggregation calculation performed by server system 104 (shown in FIG. 1), to receive alerts from server system 104 in the event investment instruments should be included in, or removed from, a fund index (also known as a basket) of investment instruments based on an updated disaggregation calculation, and to receive alerts from server system 104 in the event of an unexpected investment instrument price fluctuation, as will be described in more detail below. Client device 102 may be, but is not necessarily limited to, a computer workstation, a personal computer, a laptop or notebook computer, a tablet device or a smartphone.

In the example embodiment, client device 102 includes a processor 108 for executing instructions. In some embodiments, executable instructions are stored in a memory area 110. Processor 108 may include one or more processing units, for example, a multi-core configuration. Memory area 110 is any device allowing information such as executable instructions and/or written works to be stored and retrieved. Memory area 110 may include one or more computer readable media.

Client device 102 may also include at least one media output component 112 for presenting information to a user 114. Media output component 112 is any component capable of conveying information to user 114. In some embodiments, media output component 112 includes an output adapter such as a video adapter and/or an audio adapter. An output adapter is operatively coupled to processor 108 and operatively couplable to an output device such as a display device, a liquid crystal display (LCD), organic light emitting diode (OLED) display, or “electronic ink” display, or an audio output device, a speaker or headphones.

In some embodiments, client device 102 includes an input device 116 for receiving an input from user 114. Input device 116 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 112 and input device 116. Client device 102 may also include a communication interface 118, which is communicatively couplable server system 104 (shown in FIG. 1), for example. Communication interface 118 may include, for example, a wired or wireless network adapter or a wireless data transceiver for use with a mobile phone network, Global System for Mobile communications (GSM), 3G, or other mobile data network or Worldwide Interoperability for Microwave Access (WIMAX), or an 802.11 wireless network (WLAN).

Stored in memory area 110 are, for example, computer readable instructions for providing a user interface to user 114 via media output component 112 and, optionally, receiving and processing input from input device 116. A user interface may include, among other possibilities, a web browser and client application. Web browsers enable users, such as user 114, to display and interact with media and other information typically embedded on a web page or a website. An application allows user 114 to interact with a server application from a server system.

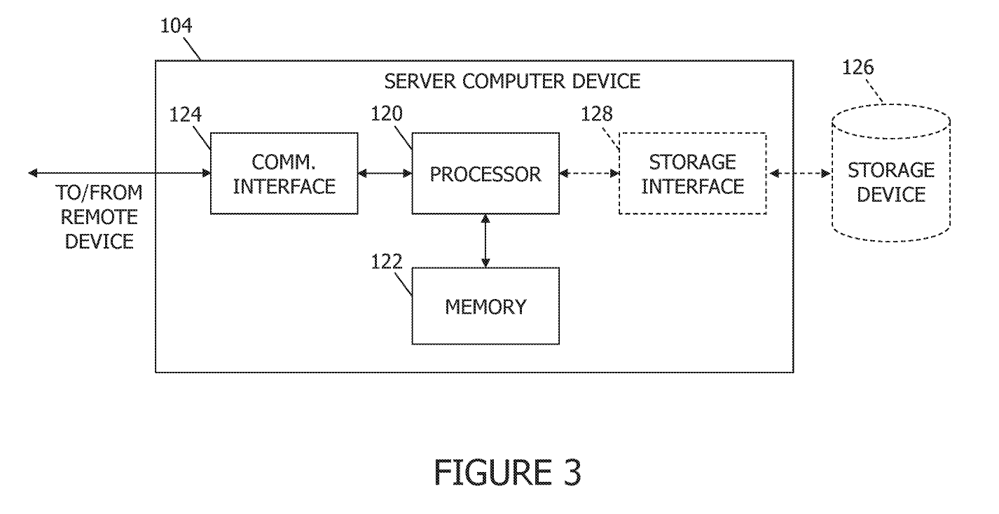

FIG. 3 is a block diagram illustrating an example server system 104 that may be used in computing system 100 (shown in FIG. 1). In the example embodiment, server system 104 is a database used to receive historic and current financial data for one or more investment instruments, to store the financial data, to send, receive, and process signals from various sources, and to perform a disaggregation calculation for the one or more investment instruments. Server system 104 includes a processor 120 for executing instructions. Instructions may be stored in a memory area 122, for example. Processor 120 may include one or more processing units (e.g., in a multi-core configuration) for executing instructions. The instructions may be executed within a variety of different operating systems on the server system 104, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 120 is operatively coupled to a communication interface 124 such that server system 104 is capable of communicating with a remote device such as client device 102, described above, or another server system 104. For example, server system 104 may be a server system, wherein communication interface 124 may receive data from financial database 106.

Processor 120 may also be operatively coupled to a storage device 126. Storage device 126 is any computer-operated hardware suitable for storing and/or retrieving data. In some embodiments, storage device 126 is integrated in server system 104. For example, server system 104 may include one or more hard disk drives as storage device 126. In other embodiments, storage device 126 is external to server system 104 and may be accessed by a plurality of server systems 104. For example, storage device 126 may include multiple storage units such as hard disks or solid state disks in a redundant array of inexpensive disks (RAID) configuration. Storage device 126 may include a storage area network (SAN) and/or a network attached storage (NAS) system.

In some embodiments, processor 120 is operatively coupled to storage device 126 via a storage interface 128. Storage interface 128 is any component capable of providing processor 120 with access to storage device 126. Storage interface 128 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 120 with access to storage device 126.

Memory area 122 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

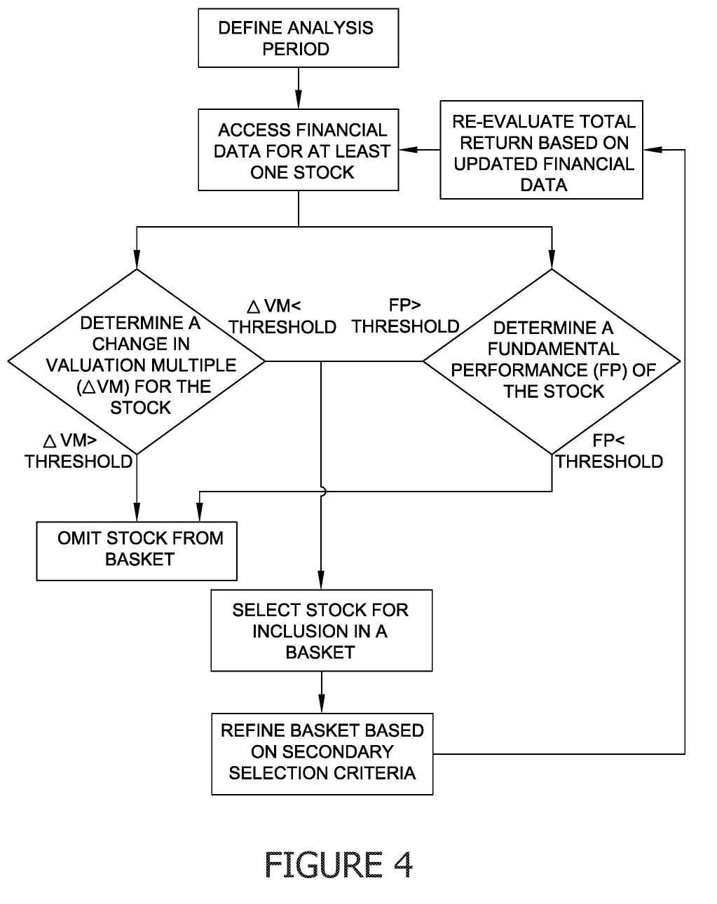

FIG. 4 is a flow diagram illustrating example instructions that may be executed by processor 120 when analyzing and creating an index portfolio. In the example embodiment, processor 120 includes instructions for analyzing a given portfolio of investment instruments, or for analyzing and selecting investment instruments from a predefined universe of investment instruments, such as a traditional market index, to create the index portfolio.

For example, when creating an enhanced index portfolio, processor 120 defines an analysis period, and accesses financial data for a plurality of investment instruments over the analysis period. In one embodiment, the analysis period is defined based on an input received from user 114 at client device 102 (both shown in FIG. 3). In addition, the analysis period spans any amount of time that enables the systems and methods to function as described herein. In some embodiments, the analysis period is at least one year, at least five years, or at least ten y ears.

After the analysis period has been defined, processor 120 accesses financial data for at least one investment instrument over the analysis period. In one embodiment, the financial data is accessed by determining a Committee on Uniform Securities Identification Procedures (CUSIP) designator for the investment instrument, and retrieving, using the CUSIP designator, the financial data for the investment instrument from a financial data service. For example, as noted above, server system 104 is in communication with financial database 106 (both shown in FIG. 1). In the example embodiment, the CUSIP designator is loaded into a database application associated with financial database 106, and the financial data is transmitted to server system 104. The financial data may then be stored in storage device 126 and accessed when determining an initial evaluation of a total return of the investment instrument, or when performing a quarterly disaggregation calculation based on the financial data, as will be explained in more detail below.

Any financial data is requested and retrieved from financial database 106 that enables the systems and methods to function as described herein. Example financial data includes, but is not limited to, an industry and/or sector, a quarterly reporting date, a quarterly revenue, a quarterly earnings before interest, tax, depreciation, and amortization (EBITDA), net cash at the end of a fiscal quarter, fully-diluted shares-outstanding at the end of a fiscal quarter, tangible book value per share at the end of a fiscal quarter, daily closing investment instrument prices, and dividends paid per share for the investment instrument over a given period of time. The financial data is then used to evaluate a total return for the investment instrument and, in some embodiments, select investment instruments for inclusion in a basket based on primary selection criteria, as will be explained in further detail below.

For example, the evaluation of the total return is based on a disaggregation and evaluation of individual sources of return that define the total return. More specifically, the total return is based on a change in valuation multiple for the investment instrument over the analysis period and a fundamental performance of the investment instrument over the analysis period.

The total return (TR) is calculated using the following equation:

$$T R = \frac{( {SP}_{1} - {SP}_{0 - 1} + Σ {D}_{0 \to 1} )}{{SP}_{0 - 1}} ,$$

where “SP” is the closing investment instrument price, “D” is dividends paid per-share, “0-1” is the trading day before the start of the analysis period, and “1” is the final trading day in the analysis period.

The change in valuation multiple (ΔVM) is calculated using one of two equations. For investment instruments that are not classified in the financial sector, the change in valuation multiple is calculated using the following equation:

$$Δ VM = \frac{( \frac{{EV}_{1}}{{EBITDA}_{1}} )}{( \frac{{EV}_{0 - 1}}{{EBITDA}_{0 - 1}} )} - 1 ,$$

where “EV” is an Enterprise Value, “EBITDA” is the most recent prior four quarters of reported EBITDA data as of a given date, “0-1” is the trading day before the start of the analysis period, and “1” is the final trading day in the analysis period.

The Enterprise Value (EV) is calculated using the following equation:

EV=SP*FDS−NC

, where “SP” is the closing investment instrument price on a given date, “FDS” is the number of fully-diluted shares outstanding at the end of the most recently completed reporting period for a given date, and “NC” is the net cash balance at the end of the most recent quarterly reporting date.

For investment instruments that are classified in the financial sector, the change in valuation multiple is calculated using the following equation:

$$Δ {VM}_{Financials} = \frac{( {P}_{1} / {TBV}_{1} )}{( {P}_{0 - 1} / {TBV}_{0} )} - 1 ,$$

where “P” is the investment instrument price, “TBV” is the most recent quarterly reported tangible book value per share as of a given date, “0-1” is the trading day before the start of the analysis period, “0” is the first trading day in the analysis period, and “1” is the final trading day in the analysis period.

The fundamental performance of the investment instruments is determined differently based on whether the investment instrument is classified in the financial sector. For investment instruments not classified in the financial sector, the fundamental performance is calculated using the following equation:

FP=RG+MC+ΔNC+ΔFDS+DY

, where “RG” is revenue growth, “MC” is margin change, “ΔNC” is a change in net cash balance, “ΔFDS” is a change in fully-diluted outstanding shares over the analysis period, and “DY” is a dividend yield.

The revenue growth (RG) is calculated using the following equation:

$$R G = \frac{{Rev}_{1}}{{Rev}_{0}} - 1 ,$$

wherein “Rev” is the most recent prior four quarters of reported revenue as of a given date, “0” is the first trading day in the analysis period, and “1” is the final trading day in the analysis period.

The margin change (MC) is calculated using the following equation:

$$M C = \frac{{EBITDA}_{1}}{{EBITDA}_{0}} - \frac{{Rev}_{1}}{{Rev}_{0}} ,$$

“EBITDA” is the most recent prior four quarters of reported EBITDA data as of a given date, “Rev” is the most recent prior four quarters of reported revenue as of a given date, “0” is the first trading day in the analysis period, and “1” is the final trading day in the analysis period.

The change in net cash balance (ΔNC) is calculated using the following equation:

$$Δ N C = \frac{{NC}_{1} - {NC}_{0}}{{SP}_{0 - 1} * {FDS}_{0}} ,$$

where “NC” is the net cash balance at the end of the most recently completed reporting period for a given date, “SP” is the closing investment instrument price, “FDS” is the number of fully-diluted shares outstanding at the end of the most recently completed reporting period for a given date, “0-1” is the trading day before the start of the analysis period, “0” is the first trading day in the analysis period, and “1” is the final trading day in the analysis period.

The change in fully-diluted outstanding shares (ΔFDS) is calculated using the following equation:

$$Δ FDS = \frac{{FDS}_{1}}{{FDS}_{0}} - 1 ,$$

where “FDS” is the number of fully-diluted shares outstanding at the end of the most recently completed reporting period for a given date, “0” is the first trading day in the analysis period, and “1” is the final trading day in the analysis period.

The dividend yield is calculated using the following equation:

$$D Y = \frac{Σ {D}_{0 \to 1}}{{SP}_{0 - 1}} ,$$

where “D” is dividends paid per-share, “SP” is the closing investment instrument price on a given date, “0-1” is the trading day before the start of the analysis period, “0” is the first trading day in the analysis period, and “1” is the final trading day in the analysis period.

For investment instruments classified in the financial sector, the fundamental performance (FP) is calculated using the following equation:

$${FP}_{Financials} = \frac{{TBV}_{1}}{{TBV}_{0}} - 1 ,$$

where “TBV” is tangible book value per-share, “0” is the first trading day in the analysis period, and “1” is the final trading day in the analysis period.

In the example embodiment, processor 120 selects investment instruments for inclusion in a basket based on primary selection criteria stored in memory area 122. The primary selection criteria is satisfied when the change in valuation multiple for the investment instrument is less than a first predetermined threshold, and when the fundamental performance of the investment instrument is greater than a second predetermined threshold. The investment instrument is selected for inclusion in the basket if both primary selection criteria are satisfied, and the investment instrument is omitted from the basket if one or both of the primary selection criteria are not satisfied.

The methodology and calculations for analyzing a portfolio and selecting investment instruments to include in the basket are repeated for a plurality of investment instruments. For example, when analyzing a given portfolio, the methodology is executed for each investment instrument in the portfolio such that the performance and viability of the portfolio can be determined. When creating an index portfolio, in some embodiments, the methodology is executed for each investment instrument in a predefined universe of investment instruments, such as a traditional market index (e.g., the Dow Jones Industrial Average, the Nasdaq Composite Index, and the S&P 500). In addition, in one embodiment, processor 120 selects a predetermined number of investment instruments to include in the basket, where the predetermined number of investment instruments are selected based on which investment instruments, having satisfied the primary selection criteria, have a greatest total return.

In some embodiments, processor 120 refines the selection of investment instruments in the basket after the preliminary selection of investment instruments is determined. More specifically, processor 120 evaluates the plurality of investment instruments in the basket based on supplemental selection criteria stored in memory area 122. The supplemental selection criteria includes at least one of revenue growth or an absolute value in valuation multiple for each investment instrument. In the example embodiment, processor 120 applies predetermined thresholds to the revenue growth and the absolute value in valuation multiple to facilitate further refining the basket and defining a revised selection of investment instruments. The data for the revised selection of investment instruments in the basket can be used to purchase securities for an index portfolio or sent to a calculation agent to create an equity index.

After the revised selection of investment instruments has been determined, processor 120 generates a spreadsheet showing the basket and the weightings of each source of return (i.e., displaying how much of the total percentage change is attributable to each source of return) for one or more historical rebalancing dates and the current basket of investment instruments. For example, in the example embodiment, the change in valuation multiple and fundamental performance of an investment instrument is determined and displayed on a quarterly basis as a function of quarterly earnings report data. The historical valuation of the investment instrument over historical rebalancing dates is determined such that the performance of the methodology can be back-tested, and such that historical alphas, determined relative to market index performance at the rebalancing dates, of the index portfolio can be determined.

In some embodiments, the financial data used to select the basket of investment instruments is periodically updated with current financial data, and the total return for investment instruments included, and not included, in the basket is re-evaluated based on the current financial data. For example, the financial data is periodically updated by accessing a most recent quarterly earnings report for a plurality of investment instruments, and the change in valuation multiple and fundamental performance for the investment instruments is re-calculated using the equations noted above. Alternatively, the financial data is periodically updated by accessing a daily closing investment instrument price for the plurality of investment instruments on a daily basis.

In these embodiments, server system 104 transmits information to client device 102 for display by the client device 102. Client device 102 includes instructions for executing a user interface to properly display the transmitted information. In some embodiments, client device 102 formats the information for display based on the device type. For example, client device 102 may display the information differently if the client device 102 is a desktop computer or a mobile computer device, such as a smart phone.

In some embodiments, processor 120 provides an alert to user 114 via client device 102 based on an outcome of the re-evaluation of investment instruments in the basket. For example, the alert is provided when an investment instrument included in the basket no longer satisfies the primary selection criteria, or when an investment instrument not previously included in the basket currently satisfies the primary selection criteria after re-evaluation of the total return. User 114 may then update the index portfolio or index based on the alert. In some embodiments, the alert is transmitted in real-time based on the current performance of investment instruments.

In one embodiment, the alert is provided to user 114 from an application loaded on client device 102. In the event an alert is generated by processor 120, the application on client device 102 is launched automatically, which causes a display on client device 102 to activate and display a graphical representation of the alert.

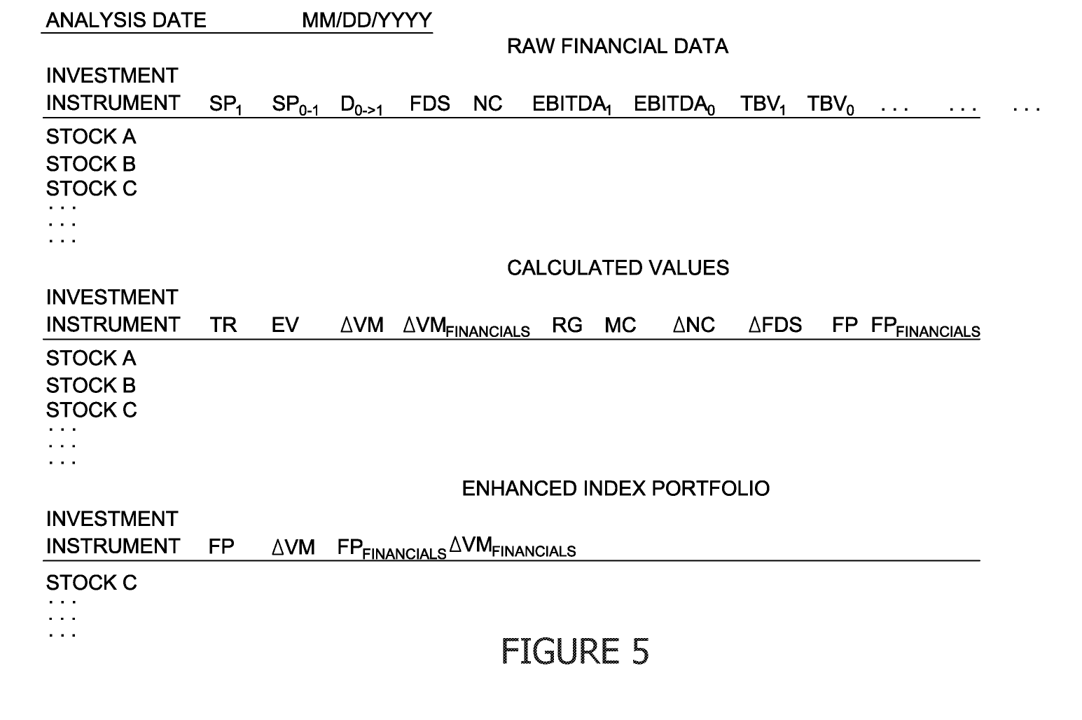

FIG. 5 is an illustration of an example spreadsheet that may be generated to analyze the results of a disaggregation calculation. In the exemplary embodiment, the spreadsheet is populated with raw financial data, such as historic and current financial data received from a subscription-based financial data service. The raw financial data is then used to perform a disaggregation calculation and determine the change in valuation multiple and fundamental performance for a plurality of investment instruments. The results of the disaggregation calculation are displayed in the spreadsheet, which enables a portfolio manager, for example, to analyze the sources of return for a portfolio of investment instruments. As such, the spreadsheet provides a tool that enables the portfolio manager to analyze a universe of investment instruments, and that facilitates selection of investment instruments by the portfolio manager for inclusion in an enhanced index portfolio.

At least one of the technical solutions to the technical problems provided by this system may include: (i) improved speed of analyzing portfolios; (ii) efficiently determining optimal composition of portfolios; (iii) decreased use of computing resources in analysis of portfolios; (iv) alerting users to potential changes to make to the composition of their portfolio based on current changes in the underlying stocks; and (v) constant real-time reassessment of portfolio composition.

The methods and systems described herein may be implemented using computer programming or engineering techniques including computer software, firmware, hardware, or any combination or subset thereof, wherein the technical effects may be achieved by performing at least one of the following steps: (a) defining an analysis period; (b) accessing, via the at least one database, financial data for a plurality of investment instruments over the analysis period; (c) accessing financial data for the plurality of investment instruments in a predefined universe of investment instruments; (d) determining a Committee on Uniform Securities Identification Procedures (CUSIP) designator for the plurality of investment instruments; (e) retrieving, using the CUSIP designator, the financial data for the plurality of investment instruments from a financial data service; (0 evaluating a total return for each investment instrument based on the financial data, wherein the evaluation includes determining a change in valuation multiple for each investment instrument over the analysis period and determining a fundamental performance of each investment instrument over the analysis period; (g) determining the fundamental performance as a function of revenue growth, margin change, a dividend yield, a change in net cash balance, and a change in fully-diluted outstanding shares over the analysis period; (h) determining, for financial sector investment instruments of the plurality of investment instruments, the change in valuation multiple and the fundamental performance as a function of at least one of a change in investment instrument price or a change in tangible book value per share over the analysis period; (i) evaluating a historical performance of investment instruments in the fund index relative to a market index performance; (j) evaluating the total return at quarterly intervals corresponding to a release of a quarterly earnings report for each investment instrument; (k) selecting investment instruments from the plurality of investment instruments to include in a fund index based on primary selection criteria, wherein the primary selection criteria is satisfied when the change in valuation multiple for an investment instrument over the analysis period is less than a first predetermined threshold, and when the fundamental performance of an investment instrument over the analysis period is greater than a second predetermined threshold; (l) evaluating the plurality of investment instruments in the fund index based on supplemental selection criteria that includes at least one of revenue growth or an absolute value in valuation multiple for each investment instrument; (m) selecting a predetermined number of investment instruments to include in the fund index, wherein the investment instruments are selected as a function of the disaggregation of the total return into the change in valuation multiple and the fundamental performance; (n) selecting the investment instruments from a predefined universe of investment instruments; (o) refining the selection of investment instruments in the fund index based on the supplemental selection criteria; (p) periodically updating the financial data with current financial data; (q) accessing a most recent quarterly earnings report for the plurality of investment instruments; (r) accessing a daily closing investment instrument price for the plurality of investment instruments; (t) re-evaluating the total return for each investment instrument of the plurality of investment instruments based on the current financial data; and (u) transmitting an alert for display on a user device when at least one of: (i) an investment instrument included in the fund index no longer satisfies the primary selection criteria after re-evaluation of the total return; or (ii) an investment instrument not previously included in the fund index currently satisfies the primary selection criteria after re-evaluation of the total return.

In some further embodiments, the technical effects may also be achieved by performing at least one of the following steps: (a) defining an analysis period, wherein the analysis period is defined by a plurality of historical rebalancing dates, wherein evaluating a total return comprises evaluating the total return at each historical rebalancing date; (b) accessing, via the database, financial data for the plurality of investment instruments over the analysis period; (c) accessing financial data for the plurality of investment instruments in a predefined universe of investment instruments; (d) determining a Committee on Uniform Securities Identification Procedures (CUSIP) designator for the plurality of investment instruments; (e) retrieving, using the CUSIP designator, the financial data for the plurality of investment instruments from a financial data service; (0 evaluating a total return for each investment instrument based on the financial data, wherein the evaluation includes determining a change in valuation multiple for each investment instrument over the analysis period and determining a fundamental performance of each investment instrument over the analysis period; and (g) evaluating the total return at quarterly intervals corresponding to a release of a quarterly earnings report for each investment instrument; perform determining, for financial sector investment instruments of the plurality of investment instruments, the change in valuation multiple and the fundamental performance as a function of at least one of a change in investment instrument price or a change in tangible book value per share over the analysis period.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose various embodiments, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for generating an index portfolio by disaggregating a total return of an investment instrument, said system comprising at least one processor in communication with at least one memory device, said at least one processor in communication with at least one database, said at least one processor programmed to perform the steps of:
defining an analysis period;
accessing, via the at least one database, financial data for a plurality of investment instruments over the analysis period;
evaluating a total return for each investment instrument based on the financial data, wherein the evaluation includes determining a change in valuation multiple for each investment instrument over the analysis period and determining a fundamental performance of each investment instrument over the analysis period; and
selecting investment instruments from the plurality of investment instruments to include in a fund index based on primary selection criteria, wherein the primary selection criteria is satisfied when the change in valuation multiple for an investment instrument over the analysis period is less than a first predetermined threshold, and when the fundamental performance of an investment instrument over the analysis period is greater than a second predetermined threshold.

2. The system in accordance with claim 1, wherein the at least one processor is programmed to perform the steps of:
evaluating the plurality of investment instruments in the fund index based on supplemental selection criteria that includes at least one of revenue growth or an absolute value in valuation multiple for each investment instrument; and
refining the selection of investment instruments in the fund index based on the supplemental selection criteria.

3. The system in accordance with claim 1, wherein the at least one processor is programmed to perform the steps of:
periodically updating the financial data with current financial data; and
re-evaluating the total return for each investment instrument of the plurality of investment instruments based on the current financial data.

4. The system in accordance with claim 3, wherein the at least one processor is programmed to perform accessing a most recent quarterly earnings report for the plurality of investment instruments.

5. The system in accordance with claim 3, wherein the at least one processor is programmed to perform the steps of accessing a daily closing investment instrument price for the plurality of investment instruments.

6. The system in accordance with claim 3, wherein the at least one processor is in communication with a user device and wherein the at least one processor is programmed to perform the steps of:
transmitting an alert for display on a user device when at least one of:
an investment instrument included in the fund index no longer satisfies the primary selection criteria after re-evaluation of the total return; or
an investment instrument not previously included in the fund index currently satisfies the primary selection criteria after re-evaluation of the total return.

7. The system in accordance with claim 1, wherein the at least one processor is programmed to perform accessing financial data for the plurality of investment instruments in a predefined universe of investment instruments.

8. The system in accordance with claim 1, wherein the at least one processor is programmed to perform the steps of:
determining a Committee on Uniform Securities Identification Procedures (CUSIP) designator for the plurality of investment instruments; and
retrieving, using the CUSIP designator, the financial data for the plurality of investment instruments from a financial data service.

9. The system in accordance with claim 1, wherein the at least one processor is programmed to perform selecting a predetermined number of investment instruments to include in the fund index, wherein the investment instruments are selected as a function of the disaggregation of the total return into the change in valuation multiple and the fundamental performance.

10. The system in accordance with claim 1, wherein the at least one processor is programmed to perform:
evaluating a total return for each investment instrument based on the equation
$$T R = \frac{( {SP}_{1} - {SP}_{0 - 1} + Σ {D}_{0 \to 1} )}{{SP}_{0 - 1}}$$
wherein “SP” represents a closing investment instrument price, “D” represents dividends paid per-share, “0-1” represents the trading day before the start of the analysis period, and “1” represents the final trading day in the analysis period.

11. The system in accordance with claim 1, wherein the at least one processor is programmed to perform determining the change in valuation multiple as a function of an investment instrument's enterprise value and earnings before interest, tax, depreciation, and amortization (EBITDA).

12. The system in accordance with claim 1, wherein the at least one processor is programmed to perform determining the fundamental performance as a function of revenue growth, margin change, a dividend yield, a change in net cash balance, and a change in fully-diluted outstanding shares over the analysis period.

13. The system in accordance with claim 1, wherein the at least one processor is programmed to perform determining, for financial sector investment instruments of the plurality of investment instruments, the change in valuation multiple and the fundamental performance as a function of at least one of a change in investment instrument price or a change in tangible book value per share over the analysis period.

14. The system in accordance with claim 1, wherein the at least one processor is programmed to perform evaluating a historical performance of investment instruments in the fund index relative to a market index performance.

15. A system for analyzing a plurality of investment instruments in a portfolio using a disaggregation calculation, said system comprising at least one processor in communication with at least one memory device, said at least one processor in communication with at least one database, said at least one processor programmed to perform the steps of
defining an analysis period;
accessing, via the database, financial data for the plurality of investment instruments over the analysis period; and
evaluating a total return for each investment instrument based on the financial data, wherein the evaluation includes determining a change in valuation multiple for each investment instrument over the analysis period and determining a fundamental performance of each investment instrument over the analysis period.

16. The system in accordance with claim 15, wherein the analysis period is defined by a plurality of historical rebalancing dates, wherein evaluating a total return comprises evaluating the total return at each historical rebalancing date.

17. The system in accordance with claim 16, wherein the at least one processor is programmed to perform evaluating the total return at quarterly intervals corresponding to a release of a quarterly earnings report for each investment instrument.

18. The system in accordance with claim 15, wherein the at least one processor is programmed to perform accessing financial data for the plurality of investment instruments in a predefined universe of investment instruments.

19. The system in accordance with claim 15, wherein the at least one processor is programmed to perform the steps of:
determining a Committee on Uniform Securities Identification Procedures (CUSIP) designator for the plurality of investment instruments; and
retrieving, using the CUSIP designator, the financial data for the plurality of investment instruments from a financial data service.

20. The system in accordance with claim 15, wherein the at least one processor is programmed to perform determining, for financial sector investment instruments of the plurality of investment instruments, the change in valuation multiple and the fundamental performance as a function of at least one of a change in investment instrument price or a change in tangible book value per share over the analysis period.
